(19) United States
(12) Patent Application Publication
(10) Pub. No.: US 2004/0079014 A1
(43) Pub. Date: Apr. 29, 2004

(54) Badge and notebook display apparatus and method of use

(76) Inventor: Emmanuel Marchand, Los Altos, CA (US)

Correspondence Address: SCHNECK & SCHNECK, P.O. BOX 2-E, SAN JOSE, CA, 95109-0005, US

(21) Appl. No.: 10/279,377

(22) Filed: Oct. 23, 2002

(51) Int. Cl. G09F 21/02

(52) U.S. Cl. 40/654.01; 40/586

(57) ABSTRACT

A badge and notebook display method and apparatus worn about a user's neck having a moveable front transparent pocket including a slot therein for accommodating a badge to be selectively displayed, a rigid rear panel resting against the user, notebook pages disposed therebetween, and a necklace connected to the pocket, panel and notebook pages, the pocket, panel and notebook pages also being connected to one another. The front panel is moveable between a first position displaying the information on the front of a badge and covering an underlying page and a second position concealing the front of the badge and displaying the underlying page. The underlying page may be a notebook page or a moveable protective cover page disposed in between the pocket and notebook pages which is moved to reveal another underlying page, typically a notebook page, before writing on the notebook page occurs. The pocket is disposed in the second position to allow for writing on the notebook pages. The necklace is of a length sufficient to allow a user to write on the notebook pages and the rigid rear panel provides a support for writing. The panel and cover may be palm size and the notebook pages and pocket may be palm size or smaller.

### TECHNICAL FIELD

The invention relates to paraphernalia used for participation and attendance at a convention, conference, seminar or the like and in particular to badge holders and notebooks.

### BACKGROUND ART

When attending events such as conventions, conferences, seminars, or the like it is important that the attendee display information, such as his or her name and company affiliation. Such identification information may be required for access to the event or may provide a means of advertisement for the company with which the attendee is affiliated. Typically, identification information is written on a badge. The badge itself may include an adhesive surface that is attached to the user to display the identification information. Alternatively, the badge may be inserted within a badge holder that is pinned or clipped to the user's clothing. Unfortunately, the adhesive badge tends to fall off of the user and the badge holder that is pinned or clipped to the user is difficult to utilize and may damage the attendee's clothing.

In addition to having to display identification information, the attendee typically desires to record, through handwriting or printing, information disseminated and to collect samples or other items distributed at the event. Often times it is difficult to carry distributed items and a notebook, which is used to take notes at the event, and to ensure that the attendee's badge is displayed.

Therefore, what is desired is an apparatus and method for easing attendance and participation at an event such as a convention, conference, seminar, or the like.

### SUMMARY OF THE INVENTION

These and other objects are achieved by a badge and notebook display apparatus and method for alternatively displaying a badge and a notebook page, the apparatus having a moveable front transparent pocket for insertion of a badge therein, a rigid rear panel, and notebook pages disposed in between the front pocket and rear panel, the front pocket being moveable between a first position, providing display of the front of the badge within the transparent pocket, and a second position concealing the front of the badge and providing display of an underlying page. In one embodiment, the underlying page is a notebook page for writing. In another embodiment, a moveable protective cover page is disposed in between the pocket and notebook pages. In order for the notebook pages to be displayed, the protective cover page is moved to display the underlying notebook page as the pocket is moved into the second position. A necklace is connected to the pocket, panel, notebook pages and cover, if present, at an upper end through a binding and is worn about a user's neck, suspending the front pocket, rear panel notebook pages, and cover such that the front transparent pocket faces outwardly and away from the user to display the badge in the first position, while the rear panel rests against the user. The necklace is of a length sufficient to allow the user to reach the notebook pages for writing when the front pocket is in the second position. The panel and cover page may be palm size and the notebook pages and pocket may be palm size or smaller. The rigid panel provides a writing support for the user in the second position, so the user is able to take notes with ease. In operation, the user alternately moves the front pocket between the first and second positions, thus displaying the front of the badge or the underlying page. If the cover page is present, it is also moved between positions displaying and concealing another underlying page, typically a notebook page.

In one embodiment, the binding includes a plurality of rings threaded through a plurality of aligned openings in the pocket, rear panel, notebook pages and cover page, if present. The pocket, rear panel, cover and notebook pages are moveable with respect to the plurality of rings and each other. More specifically, they are rotatable about the plurality of rings.

The apparatus and the method of the present invention are advantageous in that they ease attendance and participation at an event such as a convention, conference, seminar, or the like. The user is both able to display his or her badge and store notes taken at the event without the use of his hands, as the apparatus is suspended about the user's neck. Also, the apparatus includes a rigid surface for writing. Further, the apparatus is of a sufficient weight to prevent the apparatus from flipping upwardly.

### BRIEF DESCRIPTION OF THE DRAWINGS

FIG. 1 is a front plan view of the apparatus of the present invention worn by a user.

FIG. 2 is a perspective view of the apparatus of FIG. 1 with the front panel in a first position.

FIG. 3 is a perspective view of the apparatus of FIG. 1 with the front pocket in the second position.

FIG. 4 is a perspective view of the apparatus of FIG. 1 with the front pocket in the second position.

FIG. 5 is a plan view of the front of the apparatus of FIG. 1.

FIG. 6 is a plan view of the rear of the apparatus of FIG. 1.

FIG. 7 is a plan view of the apparatus of FIG. 1 with the front pocket in the second position.

### BEST MODE FOR CARRYING OUT THE INVENTION

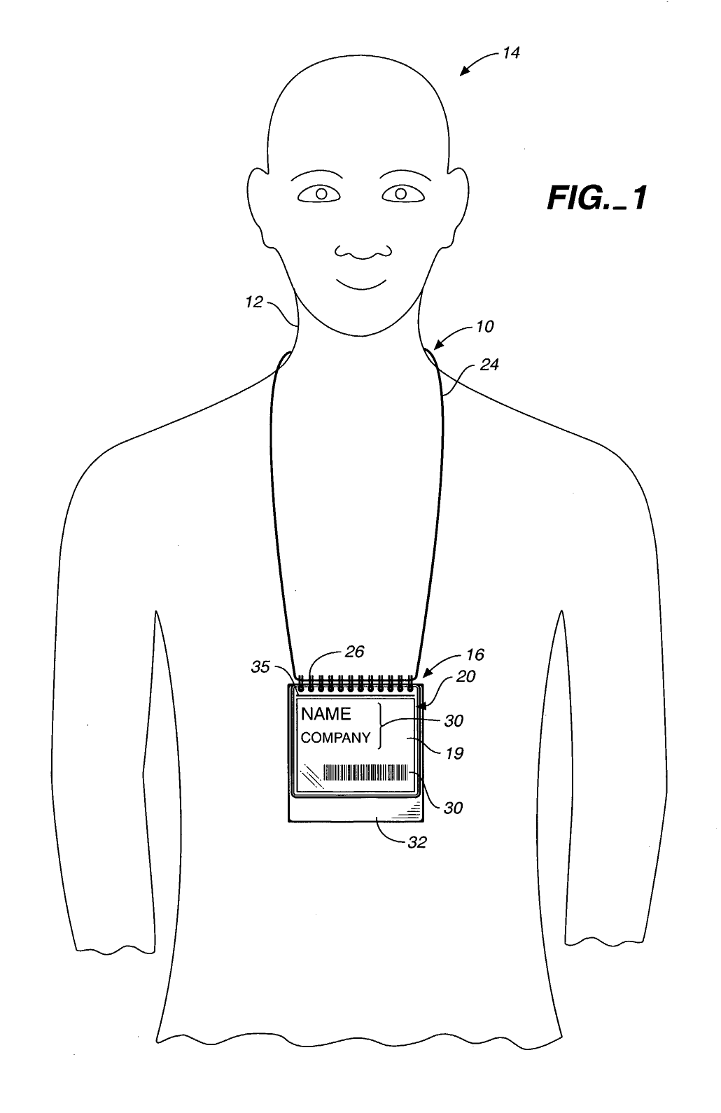

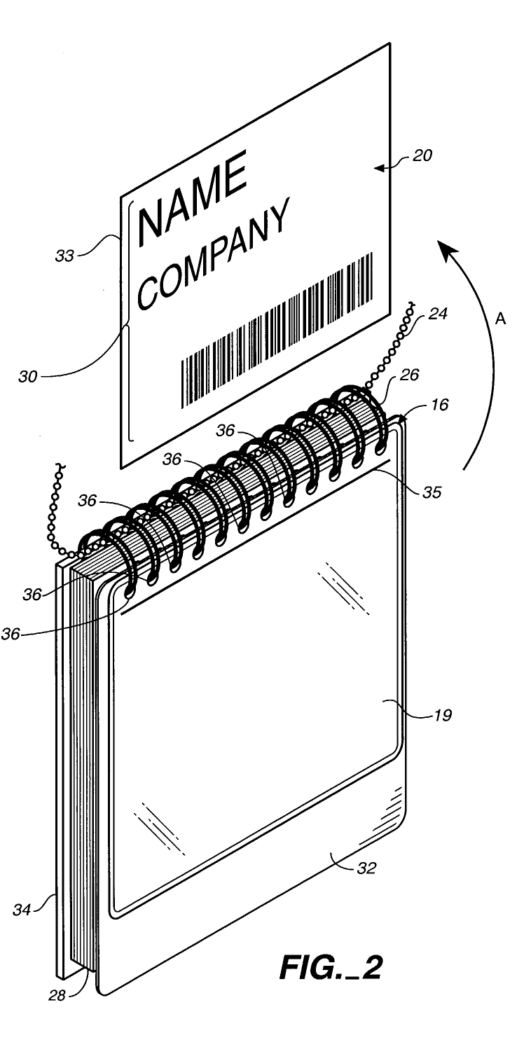

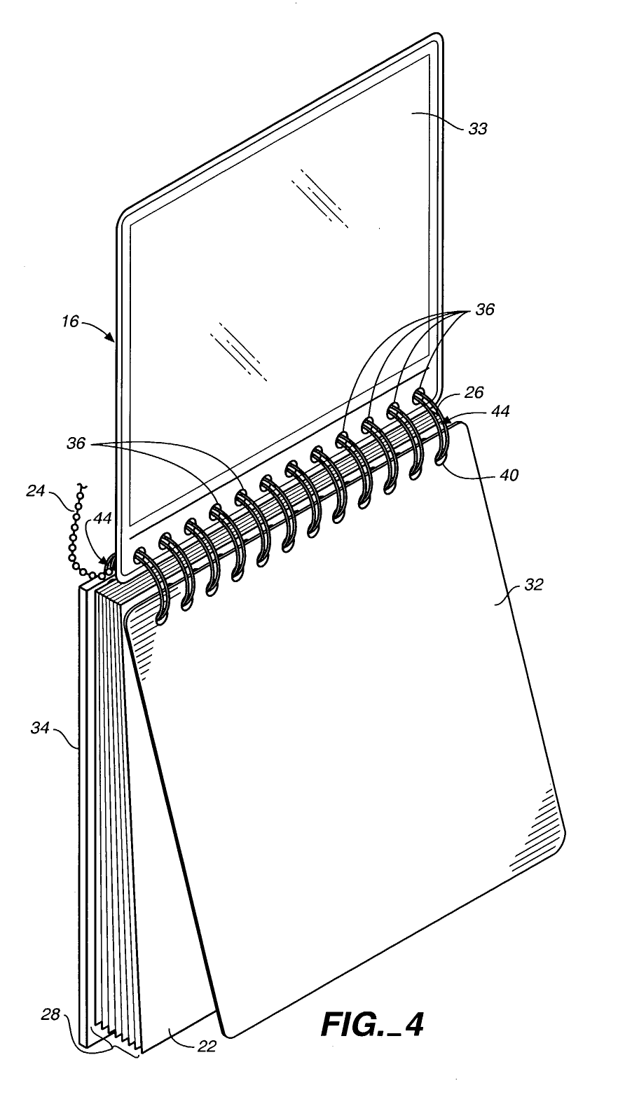

With reference to FIGS. 1 and 2, there is seen the apparatus 10 of the present invention worn about the neck 12 of a user 14 (FIG. 1). The user 14 is typically an attendee at an event such as a convention, conference, seminar, or the like, though need not be. A front transparent pocket 16 of the apparatus 10 is moveable between a badge viewing position where a badge 20 is displayed and a writing position where an underlying page, such as a top notebook page 22 (FIG. 4) for writing or recording, is displayed. Alternatively, the underlying page is a cover page 32. Cover page 32 may be disposed in between the pocket 16 and notebook pages 28. When the cover is present and the pocket 16 is in the second writing position, it is necessary that the cover page 32 be moved to display the underlying notebook pages 28, and specifically top page 22. The underlying page may be the cover page, a notebook page, or other item moveable relative to the front pocket 16, notebook pages 28 and rear cover 34. In the writing position a front surface 19 of the badge 20 is concealed.

The apparatus includes a necklace 24, such as a chain or a string connected to a binding 26, such as a plurality of rings, at one end of the apparatus 10 and worn about the user's neck at another end. The necklace 24 is of a length sufficient to allow a user to reach notebook pages 28 with his or her hand for writing when the front pocket 16 is in the writing position. For instance, the necklace may have a length of approximately 16 inches, measured from a center of the necklace at the back of the neck 12 to the tip of the apparatus 10 when worn about the user's neck. The necklace length may vary depending on the size of the user and the particular length required for the user to reach the notebook pages for writing when the apparatus is suspended from the user's neck.

Still referring to FIGS. 1 and 2, the badge 20 is seen displayed outwardly and facing away from the user 14. The badge 20, for example, displays identifying information 30 such as the user's name, company affiliation and/or a bar code storing data on a front side 50 of the badge 20. The badge 20 may display any desired information. The badge 20 is comprised of any desirable material and is, for example, made of paper.

The cover page 32 is seen disposed behind the badge 20. The cover page 32 may be plastic and may protect the notebook pages from the elements, such as for example, moisture. The cover page 32 may also be opaque so as to cover any writing on the notebook pages 28. This prevents confidential notations from being revealed. The cover page 32 is optional and if present, provides an additional weight to prevent the apparatus 16 from being inadvertently flipped upward by a breeze or the like.

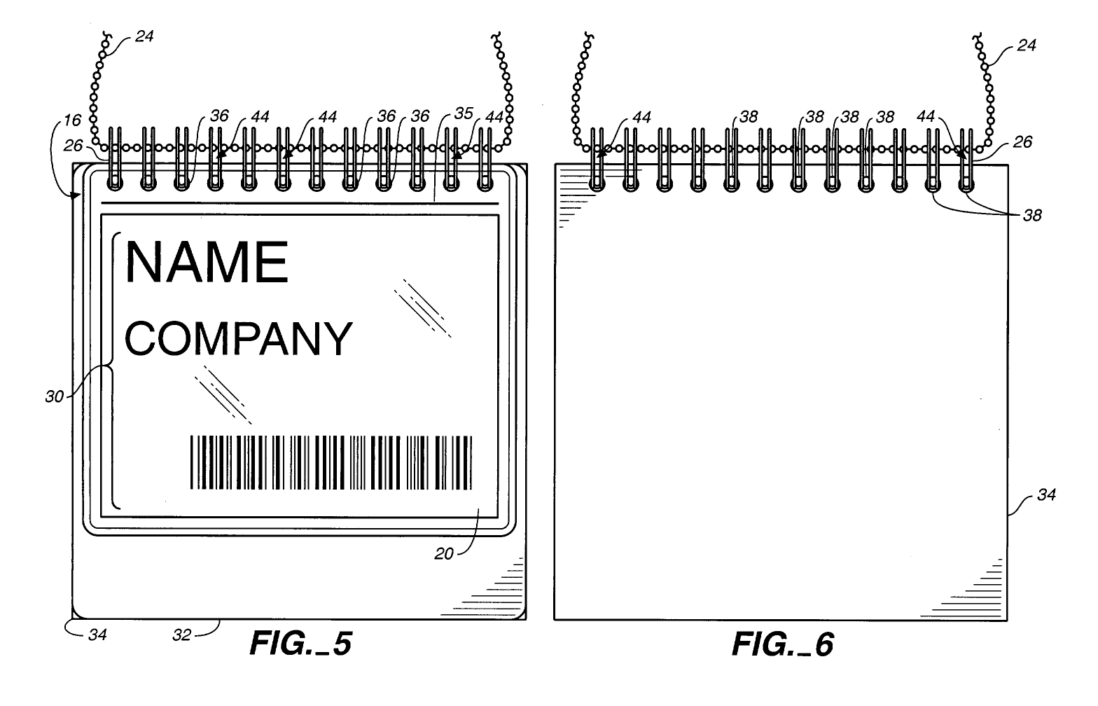

With reference to FIGS. 1, 2 and 5, the moveable front pocket 16 is seen in a first position that provides display of the front 19 of the badge 20 when inserted within the transparent pocket 16. Because at least the front side 50 the pocket 16 is transparent, the badge 20, and any information 30 on it, is visible through the transparent pocket. The pocket 16 may comprise a vinyl material. The back side 53 of the pocket may also be transparent. The front pocket 16 covers at least a portion of the front notebook page 22 (FIG. 4) in the first position. Alternatively, where the cover page 32 is present, the cover 32 covers at least a portion of the notebook page 22 and the front pocket 16 covers at least a portion of the cover in the first position.

The front pocket 16 includes an upper slot 35 for insertion of the badge 20. The pocket 16 is not as heavy as a rear panel 34, thus does not require much force on the part of the user to move it into the first or second position. The badge 20 is disposed securely within the transparent pocket. In other words, the badge fits snugly within the pocket 16 preventing it from falling out upon movement of the pocket. The rear panel 34 (a rear view of which is seen in FIG. 6) may comprise a hard cardboard material or any other material that will provide a surface rigid enough for a user to write or record information upon the notebook pages 28. Notebook pages 28, upon which a user takes notes or makes other desired writings, are disposed in between the front panel 16 and the rear panel 34. The pocket 16, panel 34 which is typically heavier than the front panel 16, and notebook pages 28 provide a weight sufficient to retain the apparatus 10 in the position seen in FIG. 1, until moved by the user 14, and to prevent 10 from being flipped upwardly or over the user's shoulder (from a breeze or the like).

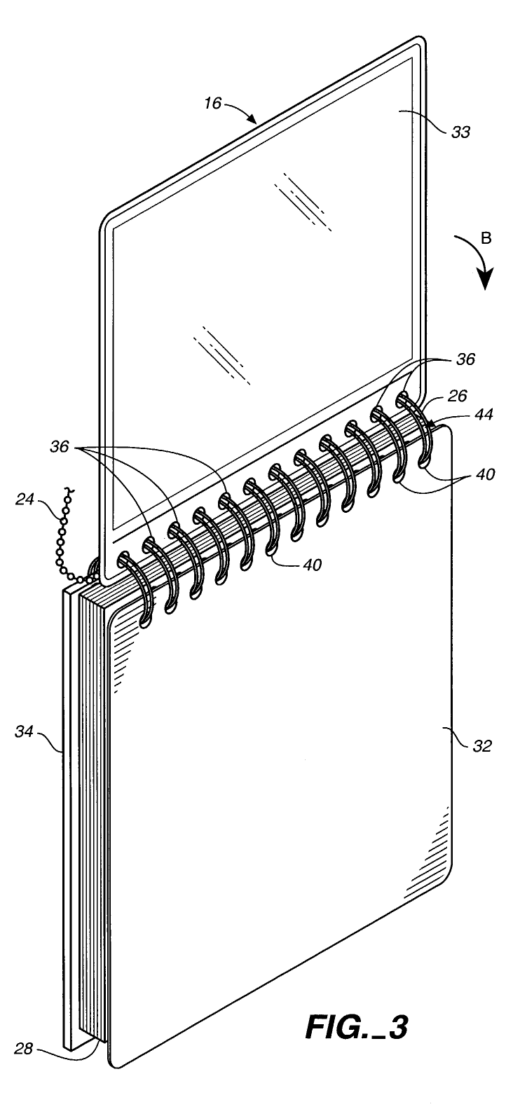

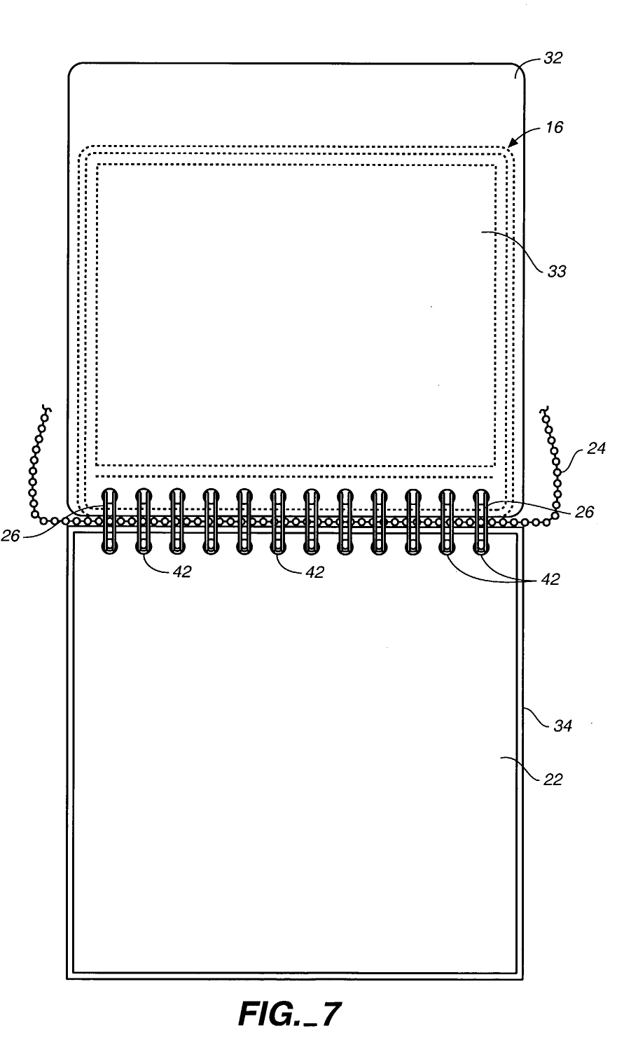

Referring to FIGS. 3, 4 and 7, the moveable front panel 16 is seen in moved into the second position in a direction away from the underlying page, for instance cover page 32, or top notebook page 22 when cover 32 is not present. In the second position, where the cover 32 is not present, a front notebook page 22 is displayed such that the user may write or make recordings upon it and such that the front 19 of badge 20 is concealed and a rear or rear surface 33 of the badge 20 is facing outwardly. Where the cover 32 is present, in addition to moving the front panel 16 to the second position to display the front page 22 of the notebook pages 28 and conceal the information 30 on the front of the badge 20, the cover 32 is also moved in a direction away from the underlying page, typically notebook page 22. In this manner, display of the front notebook page 22 occurs.

With reference to FIGS. 2-7, the binding 26, which in this example is a plurality of rings that may be connected, is seen threaded within a plurality of openings present in the front pocket 16, the cover page 32, if present, the notebook pages 28 and the rear panel 34. Thus, the binding 26 connects the pocket 16, panel 34, cover page 32 and notebook pages 28 together. The front pocket 16, rear panel 34, cover page 32 and notebook pages 28 are moveable with respect to the binding 26 and each other. More specifically, the pocket 16, panel 34, pages 28 and cover 32 are rotatable about the plurality of rings 26. Openings 36 disposed through the front pocket 16, openings 38 disposed through the rear panel 34, openings 40 disposed through the cover page 32 and openings 42 disposed through the notebook pages 28 may be in alignment with one another, as seen in FIG. 2, when the front pocket 16 is in the first position displaying the front of the badge 20 and the cover page 32 has been moved to a position covering the underlying page. The necklace 24 is threaded within linearly arranged openings 44 of the plurality of rings 26 and suspends the front pocket, rear panel, cover page and notebook pages connected to the plurality of rings 26.

The apparatus 10 is lightweight and thus easy to wear about the user's neck 12. The rear panel 34, and cover page 32 (if present) are palm size in that they are approximately the width and length of user's palm, within a few inches. For example, the rear panel may be approximately 4½ inches×4½ inches in size and the cover page may be the same or approximately the size. The front pocket 16 may be the same size or less than the size of the rear panel 34. For example, the front pocket may be approximately 3½ inches×4½ inches in size. Notebook pages 28 may be the same or approximately the same size as the rear panel 34. Typically, the notebook pages are slightly smaller than the rear panel such that the rear panel is able to provide a backing/support to the notebook page when the user writes on the pages. Typically, the cover page 32 is slightly larger than the notebook pages 28 such that it is able to cover the notebook pages 28, for reasons described above. The size of the front pocket 16, rear panel 34, notebook pages 28 and cover page 32 may vary in size by a few inches.

In operation, the user places the badge 20 within the transparent pocket 16 of the apparatus 10. The user places the necklace 24 connected to the binding 26 about his neck 12 to suspend the front pocket 16, rear panel 34, cover page 32, if present, and notebook pages 28 such that the front of the badge 20 within the transparent pocket 16 is displayed outwardly and the rigid rear panel 34 rests against the user 16. The badge may be placed within the pocket 16 before or after the apparatus 10 is worn about the user's neck 12. In the first position, the user 14 displays the information on the badge 20.

When the user desires to take notes or make other writings, he or she moves the front pocket 16 to the second position in a direction away from the underlying page 34, such that the underlying page is displayed and the front of the badge 20 is concealed. When the cover page 32 is not present, the front notebook page 22 is displayed when the pocket is in the second position. When the cover page 32 is present, the user also moves the cover page 32 in a direction away from another underlying page to display the other underlying page which is typically the top notebook page 22. The movement may involve rotating the front panel 16 and cover page 32 about the rings 26 as described above. With the notebook page 22 displayed, the user is able to write upon it. When desired, the user is able to move the top notebook page 22 in a direction away from the next underlying page such that the user is able to write on the next page, which becomes the top page 22. This process of revealing the next underlying page may be repeated. The rigid rear panel 34 of the apparatus provides a support for writing on the pages 28. The rigid rear panel 34 is pressed against the user 14 as the user writes.

When the user 14 is finished writing and/or desires to display the front of the badge 20 again, the front panel 16 and any cover 32 or notebook pages 28 that were moved away from their respective underlying pages are moved back to the first position in a direction of movement that is toward the respective underlying page.

With reference to FIG. 2, the pocket 16, seen in the first position, is moved in the direction indicated by arrow A toward an upper part of the user 14 (FIG. 1). The movement in the direction of arrow A results in the position of the pocket 16 seen in FIG. 3, which is the second position. With reference to FIG. 3, the pocket 16 is moved in the direction indicated by arrow B toward a lower part of the user 14 (FIG. 1). The movement in the direction of arrow B results in the position of the pocket 16 seen in FIG. 2. The front pocket 16 is typically retained in the first position until moved by the user 14.

What is claimed is:

1. A badge and notebook display apparatus, comprising:
a palm size rigid rear panel;
a front transparent pocket including an upper slot for insertion of a badge therein, said front pocket the same size as or smaller than said rear panel;
notebook pages, the same size as or smaller than said rear panel, disposed in between said front and rear panels;
a binding connecting said front pocket, rear panel and said notebook pages at an upper end wherein said front pocket is moveable relative to said binding between a first position displaying a front of said badge within said transparent pocket and a second position concealing said front of said badge and displaying an underlying page, said rigid panel providing a writing support in said second position; and
a necklace connected to said binding at one end and disposed about a user's neck at another end such that said front transparent pocket faces outwardly and away from said user in said first position and said rear panel rests against said user in said first and second positions.

2. The apparatus of claim 1 wherein said underlying page is a notebook page.

3. The apparatus of claim 1 further comprising a moveable cover page disposed in between said transparent pocket and notebook pages and connected to said binding wherein said underlying page is said cover page.

4. The apparatus of claim 3 wherein said cover page is plastic.

5. The apparatus of claim 3 wherein said cover page is moveable between a position concealing another underlying page and a position displaying said another underlying page.

6. The apparatus of claim 5 wherein said transparent pocket is disposed in said second position when said cover page is disposed in said displaying position.

7. The apparatus of claim 1 wherein said chain is of a length sufficient to allow a user to reach said underlying page when said front pocket is in said second position.

8. The apparatus of claim 1 wherein said necklace includes a chain.

9. The apparatus of claim 1 wherein said badge is disposed securely within said transparent pocket.

10. The apparatus of claim 1 wherein said binding includes a plurality of rings.

11. The apparatus of claim 10 wherein said pocket, panel and notebook pages include a plurality of openings wherein said rings are threaded within said openings.

12. The apparatus of claim 1 wherein said pocket, panel and notebook pages provide a weight sufficient to prevent said apparatus from being flipped upwardly.

13. The apparatus of claim 1 wherein said rear panel is heavier than said front pocket.

14. A method for using a badge and notebook display apparatus including a front transparent pocket, a rigid rear panel, notebook pages disposed between said panels, and a necklace connected to an upper end of the pocket, panel and notebook pages, comprising:
placing a badge within said front transparent pocket;
placing said necklace about a user's neck such that a front of said badge within said transparent pocket is displayed outwardly and said rigid rear panel rests against said user; and
moving said front pocket away from an underlying page such that said underlying page is displayed and said front of said badge is concealed.

15. The method of claim 14 further comprising writing on said underlying page.

16. The method of claim 15 further comprising providing a writing support.

17. The method of claim 14 further comprising moving said front pocket towards said underlying page and displaying said badge.

18. The method of claim 14 further comprising moving said front pocket towards said underlying page covering said underlying page.

19. The method of claim 14 further comprising moving said underlying page away from another underlying page revealing said another underlying page.

20. The method of claim 14 wherein writing includes pressing down upon said notebook pages and said rear panel.

21. A badge and notebook display apparatus, comprising,
a palm size rigid rear panel having a first plurality of openings at an upper end of said rear panel;
a front transparent pocket the same size as or smaller than said rear panel, including an upper slot for insertion of a badge therein and having a second plurality of openings at an upper end of said pocket alignable with said first plurality of openings;
notebook pages the same size as or smaller than said rear panel, disposed in between said front pocket and rear panel and having a third plurality of openings at an upper end of said notebook pages, said third plurality of openings alignable with said first and second plurality of openings;
a binding including a plurality of rings having linearly arranged openings, said binding being threaded through said first, second and third plurality of openings such that said front pocket, rear panel, and notebook pages are moveable with respect to said binding and each other and said front pocket is moveable between a badge viewing position wherein a front of said badge within said transparent pocket is displayed and a writing position wherein a underlying page is displayed and said front of said badge is concealed, said rigid rear panel providing a writing surface; and
a necklace threaded within said binding openings at one end and worn about a user's neck at another end, said necklace suspending said pocket, panel and notebook pages wherein said necklace is of a length sufficient to allow a user to reach said underlying page.

22. The apparatus of claim 21 further comprising:
a palm size cover page, disposed between said pocket and notebook pages, having a fourth plurality of openings alignable with said first, second and third plurality of openings, and being moveable between a position concealing another underlying page and a position displaying said another underlying page.

23. The apparatus of claim 21 wherein said underlying page is a notebook page.

24. The apparatus of claim 21 wherein said pocket, panel and notebook pages are rotatably connected.
